(19) United States
(12) Patent Application Publication
(10) Pub. No.: US 2012/0320591 A1
(43) Pub. Date: Dec. 20, 2012

(54) LIGHT BULB

(75) Inventors: CHIH-MING LIAO, TAOYUAN (TW); CHAO-KUN CHAN, TAOYUAN (TW); JIH-SHENG HUANG, TAOYUAN (TW); CHI-FU CHUANG, NEW TAIPEI CITY (TW)

(73) Assignee: ENLIGHT CORPORATION, TAOYUAN (TW)

(21) Appl. No.: 13/244,523

(22) Filed: Sep. 25, 2011

(30) Foreign Application Priority Data
Jun. 17, 2011 (TW) 100211072

(51) Int. Cl. F21V 29/00

(52) U.S. Cl. 362/249.02

(57) ABSTRACT

The instant disclosure relates to a light bulb, which includes a base, a conducting cap arranged on one end of the base, a heat-dissipating member disposed on the opposite end of the base, and a lamp cover. The heat-dissipating member has a wedged structure, and a plurality of inclined surfaces are formed adjacently thereon. A plurality of LEDs is disposed on the inclined surfaces, and the lamp cover is arranged over the wedged structure and the LEDs. The instant disclosure uses the LEDs to replace tungsten filament as the light sources, and arranging the LEDs on the wedged structure of the heat-dissipating member. Thereby, the light bulb can have higher heat-dissipating rate.

### BACKGROUND OF THE INVENTION

1. Field of the Invention

The instant disclosure relates to a light bulb; more particularly, to a light bulb using light-emitting diodes (LEDs) as the light sources.

2. Description of Related Art

Although incandescent light bulbs are widely used, they have several disadvantages such as high power consumption, short service life, and low brightness. Whereas the light-emitting diodes (LEDs) are more energy-efficient, have longer useful life, are brighter, and do not have to worry about the tungsten filament been burned out. Therefore, the conventional incandescent light bulbs are gradually being phased out in favor of the LEDs.

However, when in use, the LEDs tend to generate much heat. Thus, how to provide a LED light bulb having high heat dissipation rate is an important topic in today's industry.

To address the above issue, the inventors strive via industrial experience and academic research to present the instant disclosure, which can effectively improve the limitation described above.

### SUMMARY OF THE INVENTION

The instant disclosure provides a light bulb having improved heat dissipation conducting capability.

The light bulb comprises: a base; a conducting cap disposed on end of the base; a heat-dissipating member disposed on opposite end of the base, where the heat-dissipating member having a wedged structure with multiple outer surfaces; a plurality of LEDs disposed on the wedged structure; and a lamp cover enclosing the wedged structure and the LEDs.

The light bulb of the instant disclosure has the following advantages. The tungsten filament is replaced by LEDs as the light source to be more energy-efficient, have longer service life, and brighter. Moreover, by disposing the LEDs on the inclined surfaces of the wedged structure, heat can be dissipated more quickly by the heat dissipating characteristics of the heat-dissipating member and the heat-transferring properties of the wedged structure. The inclined surfaces also increase the overall heat-dissipating area for enhancing heat dissipation.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an exploded view of a light bulb for the first embodiment of the instant disclosure.

FIG. 2 is an assembled view of the light bulb for the first embodiment of the instant disclosure.

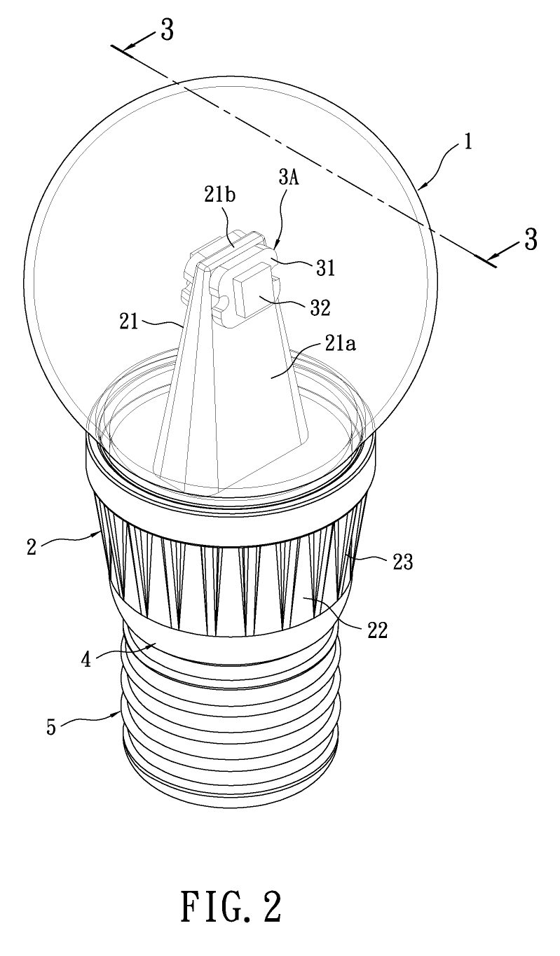

FIG. 3 is a sectional view of FIG. 2 taken along a cutting plane 3-3.

FIG. 4 is a perspective view of the light bulb for a second embodiment of the instant disclosure, where a lamp cover is separated from a heat-dissipating member.

FIG. 5 is a perspective view of the light bulb for a third embodiment of the instant disclosure, where the lamp cover is separated from the heat-dissipating member.

FIG. 6 is a perspective view of the light bulb for a fourth embodiment of the instant disclosure, where the lamp cover is separated from the heat-dissipating member.

### DETAILED DESCRIPTION OF PREFERRED EMBODIMENTS

### First Embodiment

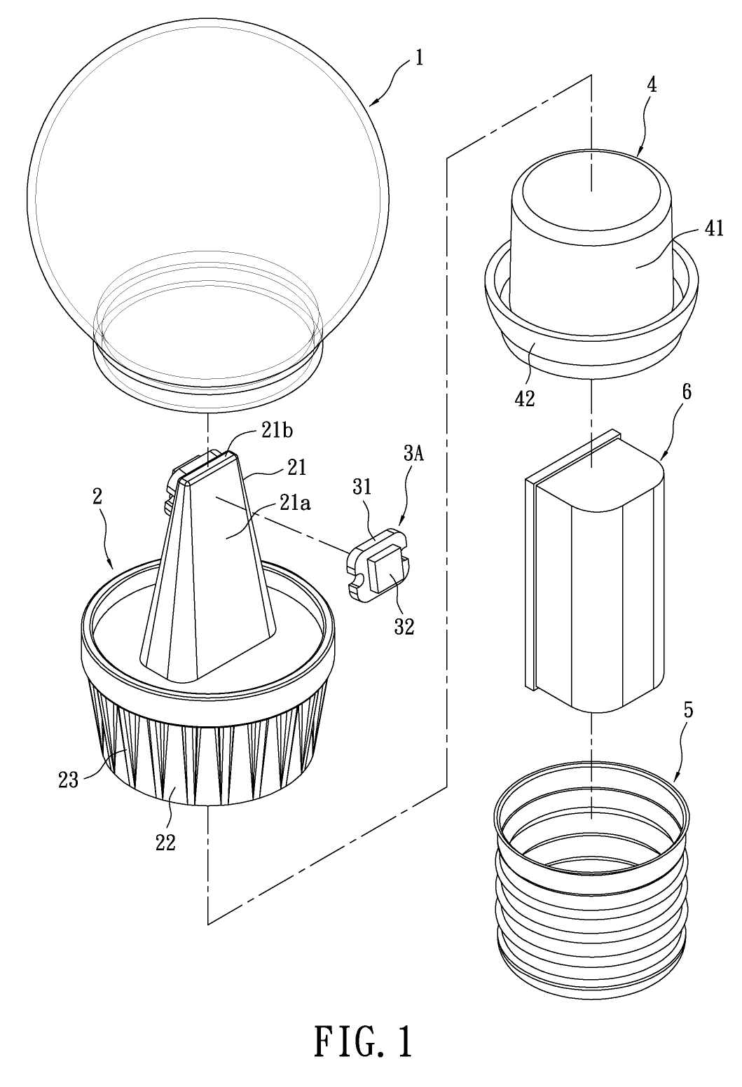

Please refer to FIGS. 1˜3, which show a light bulb for a first embodiment of the instant disclosure. By using the LEDs as the light source, the light bulb comprises a base 4, a conducting cap 5, a heat-dissipating member 2, a plurality of LEDs 3A, and a lamp cover 1. The conducting cap 5, such as the threaded cap shown in the instant figures used for housing the electrical connectors and/or provide electrical connection, is disposed on one end, such as the bottom end as shown in the figures, of the base 4. Nor is the structural appearance or the function of the conducting cap 5 is the focus of the instant disclosure, therefore no further related description is given herein.

The heat-dissipating member 2 is made of thermally conductive metal material, such as aluminum. Structurally, the heat-dissipating member 2 may be a solid or hollow body. The heat-dissipating member 2 is arranged on the other end, such as the top end as shown in the figures, of the base 4. The heat-dissipating body 2 includes a main body 22 and a wedged structure 21. A plurality of heat-dissipating fins 23 is disposed on the periphery of the main body 22. The wedged structure 21 is formed integrally with the main body 22 in one piece, and a plurality of inclined surfaces 21a are formed adjacently on the wedged structure 21. The end portion, or the tip portion as shown in the figures, of the wedged structure 21 forms a flat surface 21b.

The LEDs 3A are disposed on the inclined surfaces 21a. Each LED 3A has an aluminum substrate 31 and a light-emitting portion 32a. connected thereto. For the instant embodiment, the wedged structure 21 has a quadrilateral pyramid-like body having four inclined surfaces 21a. The quantity of the LED 3A is two, and the two aluminum substrates 31 are arranged on opposite inclined surfaces 21a of the wedged structure 21. Thereby, heat generated by the LEDs 3A can be transferred to the wedged structure 21 via the aluminum substrates 32, and be dissipated by the main body 22 of the heat-dissipating member 2 to achieve excellent heat dissipation.

The lamp cover 1 is disposed on the main body 22 of the heat-dissipating member 2, to enclose the wedged structure 21 and the LEDs 3A. The lamp cover 1 can be ball- or oval-shaped, and be made of transparent glass material or plastic material for frosted light bulb. However, the shape and material of the lamp cover 1 are not restricted. The light rays emitted by the light-emitting portions 32 of the LEDs 3A can penetrate the lamp cover 1 and be projected outwardly.

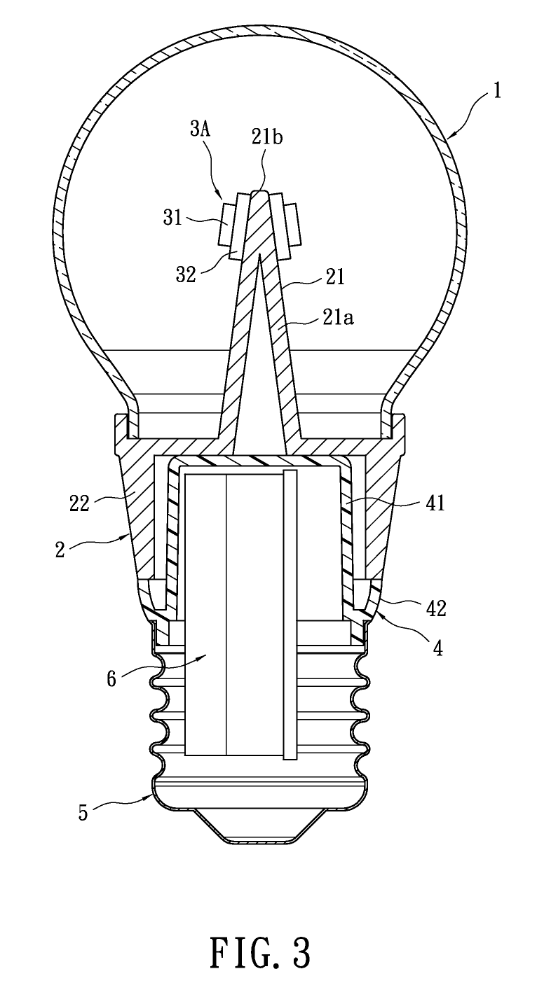

Please refer back to FIGS. 1 and 3, where the base 4 further includes a hollow body 41 and a mating portion 42 extended therefrom. The hollow body 41 is used to receive a driving circuit unit 6. The driving circuit unit 6 is electrically coupled to the conducting cap 5 and the LEDs 3A. The mating portion 42 is abutted to the main body 22 of the heat-dissipating member 2 and the conducting cap 5 in opposite directions.

### Second Embodiment

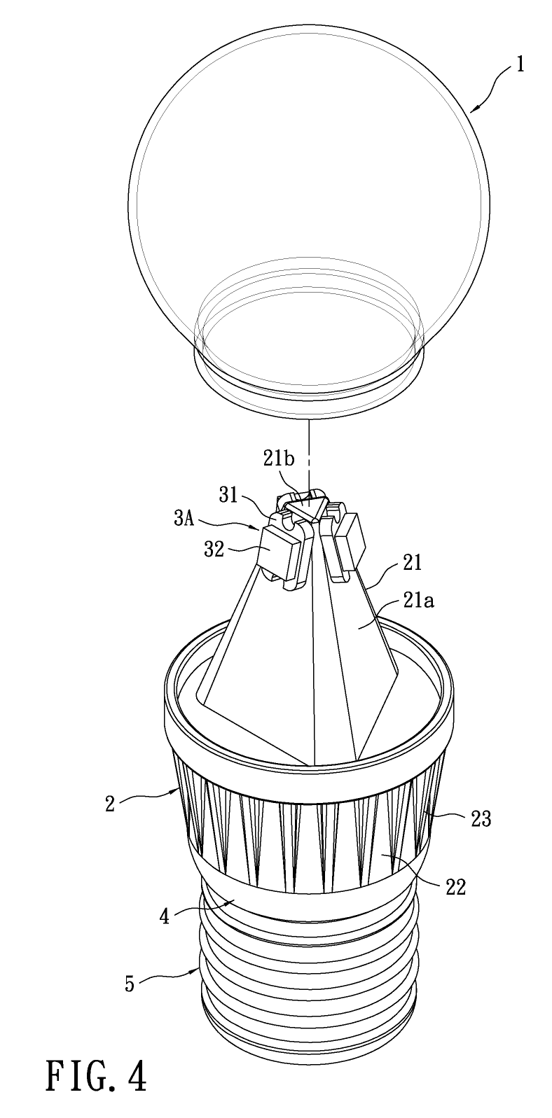

Please refer to FIG. 4, which shows a light bulb for a second embodiment of the instant disclosure. The same numerals have been used in FIG. 4 to indicate identical components between the embodiments. The second embodiment differs from the previous embodiment by: the wedged structure 21 has a triangular pyramid-like shape with a triangular base and three inclined surfaces 21A. The number of LEDs 3A is three, and each of the aluminum substrates 31 of the LEDs 3A is arranged on the corresponding inclined surface 21a of the wedged structure 21. Therefore, the instant embodiment provides light bulb having a light-emitting structure with three light-emitting planes.

### Third Embodiment

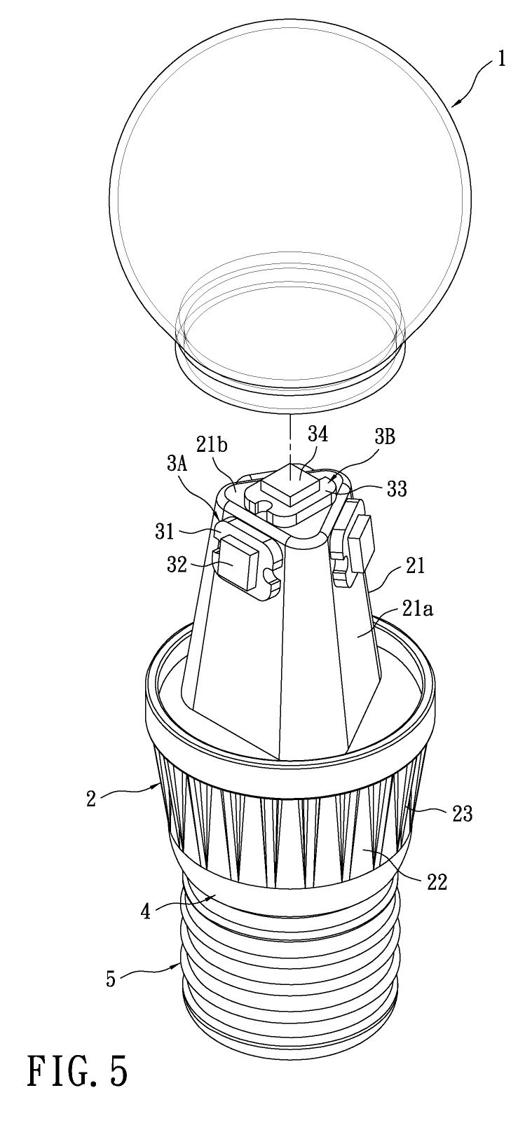

Please refer to FIG. 5, which shows a light bulb for a third embodiment of the instant disclosure. Likewise, same numerals have been used in FIG. 5 to indicate identical components between the embodiments. The third embodiment differs from the previous embodiments by: a LED 3B is further disposed on the flat surface 21B at the top portion of the wedged structure 21. The lamp cover 1 is arranged over the wedged structure 21, the LEDs 3A, and the LED 3B. Therefore, the instant embodiment provides a light bulb having a light-emitting structure with four light-emitting planes. The LED 3B includes an aluminum substrate 33 and a light-emitting portion 34 connected thereto. The aluminum substrate 33 is arranged on the top flat surface 21b. Like other LEDs 3A, heat generated by the LED 3B can be transferred to the wedged structure 21 and dissipated through the heat-dissipating member 2.

### Fourth Embodiment

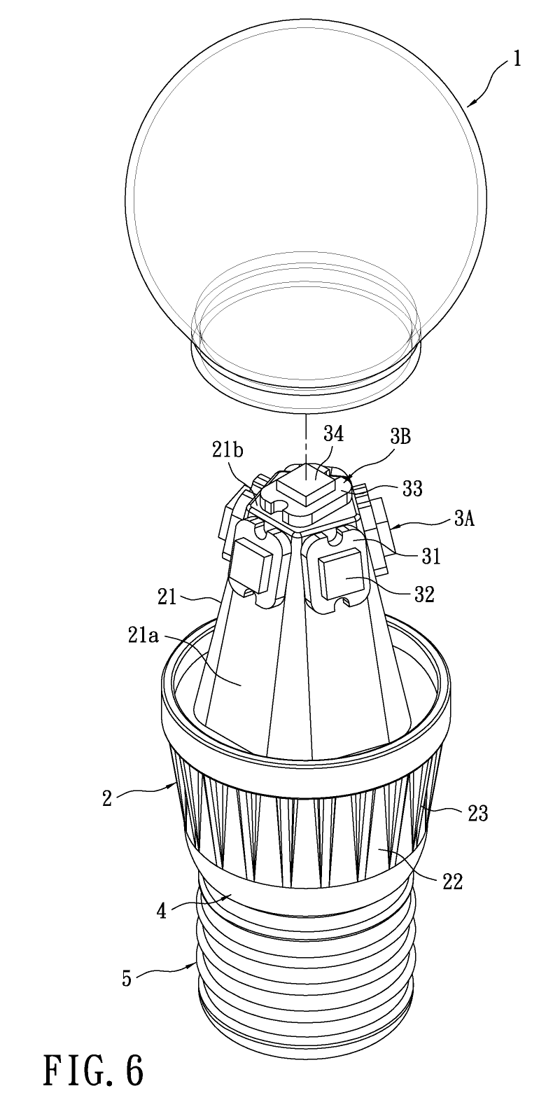

Please refer to FIG. 6, which shows a light bulb for a fourth embodiment of the instant disclosure. Same numerals are used in FIG. 6 to indicate identical components between the embodiments. The fourth embodiment differs from the previous embodiments by: the wedge structure 21 is a flat-topped pentagonal pyramid having a pentagonal base with five inclined surfaces 21a. Each inclined surface 21a is arranged with one LED 3A thereon, while the LED 3B is disposed on the flat surface 21b at the top portion of the wedged structure 21. Therefore, the instant embodiment provides a light bulb having a light-emitting structure with six light-emitting planes.

Based on the above, the instant disclosure uses the LEDs to replace the tungsten filament as the light source. Thereby, the light bulb is more energy-efficient, has longer service life, and can be brighter. Furthermore, each of the LEDs is disposed on the corresponding surface of the wedged structure, such that heat can be quickly dissipated through the heat-dissipating member and by the heat transferring properties of the wedged structure. Moreover, the multiple surfaces of the wedged structure increase the overall heat-dissipating area, which enhances the heat dissipating rate of the light bulb. In addition, the above embodiments are only for exemplary purposes. The shape of the wedged structure is not restricted, as long as it has a polygonal base with multiple surfaces for mounting the LEDs.

Further still, the LEDs are arranged on different inclined surfaces of the wedged structure in the instant disclosure. Such configuration allows light to be projected toward different directions by the LEDs, which expands the illuminating angle and projecting range of the light bulb. Plus, by further arranging the LED on the flat top surface of the wedged structure, the illuminating angle and projecting range of the light bulb can be further expanded.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A light bulb, comprising:
a base;
a threaded conducting cap disposed on one end of the base;
a heat-dissipating member disposed on the other end of the base opposite of the conducting cap, wherein the heat-dissipating member includes a wedged structure defined by a plurality of adjacently-joined inclined surfaces;
a plurality of light-emitting diodes (LEDs) selectively and respectively disposed on each of the inclined surfaces; and
a lamp cover enclosingly disposed over the wedged structure and the LEDs.

2. The light bulb of claim 1, wherein each LED has an aluminum substrate arranged on the corresponding inclined surface.

3. The light bulb of claim 1, wherein the heat-dissipating member has a main body formed integrally with the wedged structure, and wherein the lamp cover is disposed on the main body.

4. The light bulb of claim 3, wherein a plurality of heat-dissipating fins is arranged on the periphery of the main body.

5. The light bulb of claim 1, wherein the wedged structure has a substantially regular polygonal base.

6. The light bulb of claim 1, wherein the lamp cover is ball or oval shaped.

7. The light bulb of claim 2, wherein the heat-dissipating member has a main body formed integrally with the wedged structure, and wherein the lamp cover is disposed on the main body.

8. The light bulb of claim 7, wherein a plurality of heat-dissipating fins is arranged on the periphery of the main body.

9. The light bulb of claim 2, wherein the wedged structure has a substantially regular polygonal base.

10. The light bulb of claim 2, wherein the lamp cover is ball or oval shaped.

11. The light bulb of claim 2, wherein a flat top surface is formed centrally on the converging portion of the wedged structure, and wherein a separate LED is disposed on the flat top surface and covered by the lamp cover.

12. The light bulb of claim 11, wherein the heat-dissipating member has a main body formed integrally with the wedged structure, and wherein the lamp cover is disposed on the main body.

13. The light bulb of claim 12, wherein a plurality of heat-dissipating fins is arranged on the periphery of the main body.

14. The light bulb of claim 11, wherein the wedged structure has a substantially regular polygonal base.

15. The light bulb of claim 11, wherein the lamp cover is ball or oval shaped.

16. The light bulb of claim 11, wherein the LED includes an aluminum substrate arranged on the flat top surface.

17. The light bulb of claim 16, wherein the heat-dissipating member has a main body formed integrally with the wedged structure, and wherein the lamp cover is disposed on the main body.

18. The light bulb of claim 17, wherein a plurality of heat-dissipating fins is arranged on the periphery of the main body.

19. The light bulb of claim 16, wherein the wedged structure has a substantially regular polygonal base.

20. The light bulb of claim 16, wherein the lamp cover is ball or oval shaped.
